(19) United States
(12) Patent Application Publication
(10) Pub. No.: US 2024/0068859 A1
(43) Pub. Date: Feb. 29, 2024

(54) SYSTEMS AND METHODS FOR DETECTING A CRYOGENIC FLUID LEVEL IN A CONTAINER

(71) Applicant: AmericanPharma Technologies, Inc., Boise, ID (US)

(72) Inventors: Michael R. Rusnack, Meridian, ID (US); Casey A. Harris, Las Vegas, NV (US)

(21) Appl. No.: 17/821,750

(22) Filed: Aug. 23, 2022

(51) Int. Cl. G01F 23/24

(52) U.S. Cl. CPC G01F 23/246

(57) ABSTRACT

Embodiments disclosed relate to systems and methods for detecting a cryogenic fluid level in a container. In an embodiment, a system includes a plurality of sensors and a controller. Each sensor of the plurality of sensors is configured to detect a property relating to a phase of cryogenic fluid. The plurality of sensors are coupled together and vertically spaced from one another when positioned in the container. The controller coupled to the plurality of sensors and configured to determine an approximate cryogenic fluid level in the container based on a single measurement derived from the plurality of sensors.

### BACKGROUND

Regulatory requirements mandate the measurement of the cryogenic fluid level within the industry of cryogenic storage. Manual measurement is the most common methodology to measure a level of the cryogenic fluid in a container. A steel meter stick is inserted into the bottom of the container and removed, with the frost line on the steel stick indicating the depth of the cryogenic fluid. Typically, the data is then manually recorded. This operation is repeated at regular intervals per the published requirements. The presence of cryogenic fluid may be recorded by immersing a measurement probe below the fluid level. The data presented by this measurement system typically records the observations that the probe is immersed in cryogenic fluid or in the presence of the cryogenic vapor. A measurement device capable of discerning the change in the level of the cryogenic fluid that is easily employed with reasonable accuracy is needed.

### SUMMARY

Embodiments disclosed herein include systems and methods for detecting a cryogenic fluid level in a container. In an embodiment, a system includes a sensing device and a controller. The sensing device includes a plurality of sensors, each sensor of the plurality of sensors being configured to detect a property relating to a phase of cryogenic fluid. The plurality of sensors are coupled together and vertically spaced from one another when positioned in the container. The controller is coupled to the sensing device and configured to determine an approximate cryogenic fluid level in the container based on a single measurement derived from the plurality of sensors.

In an embodiment, a method for detecting a cryogenic fluid level in a container is described. The method includes detecting, with a sensing device, a property relating to a phase of cryogenic fluid. The sensing device includes a plurality of sensors coupled together and vertically spaced from one another in the container. The method also includes determining, with a controller coupled to the plurality of sensors, an approximate cryogenic fluid level in the container based on a single measurement derived from the plurality of sensors.

Features from any of the disclosed embodiments may be used in combination with one another, without limitation. In addition, other features and advantages of the present disclosure will become apparent to those of ordinary skill in the art through consideration of the following detailed description and the accompanying drawings.

### BRIEF DESCRIPTION OF THE DRAWINGS

The drawings illustrate several embodiments of the present disclosure, wherein identical reference numerals refer to identical or similar elements or features in different views or embodiments shown in the drawings.

FIGS. 1 and 2 are diagrams of a system for detecting a cryogenic fluid level in a container, according to an embodiment.

FIG. 3A is a diagram of a sensing device having a plurality of resistance temperature detectors in a series circuit, according to an embodiment.

FIG. 3B is a diagram of a sensing device having a plurality of resistance temperature detectors in a parallel circuit, according to an embodiment.

FIG. 3C is a diagram of a sensing device having a plurality of thermocouples in a series circuit, according to an embodiment.

FIG. 4 is a flow diagram for detecting a cryogenic fluid level in a container, according to an embodiment.

FIG. 5 is a block diagram of a controller, according to an embodiment.

### DETAILED DESCRIPTION

Systems and methods described herein may be utilized to automatically monitor, record, and/or provide an alert related to the storage conditions for products stored under cryogenic conditions. In some systems and methods, a cryogenic fluid (e.g., nitrogen, helium, argon, methane, or carbon monoxide) is stored in a container (e.g., Dewar). In conventional systems, a cryogenic fluid level in a container is regularly measured using a meter stick. Conventional systems and methods for measuring cryogenic fluid in a container have not met industry requirements while maintaining reliability.

Systems and methods described herein provide a cost-effective and efficient solution to determine a cryogenic fluid level in a container by utilizing different properties of the cryogenic fluid at the liquid phase or the vapor phase. For example, the liquid phase and vapor phase of cryogenic fluid can be differentiated by temperature, resistance, and/or voltage. In some embodiments, the physical characteristics of the liquid phase and vapor phase of cryogenic fluids is utilized by regularly and vertically spacing cascaded measurement sensors in a container holding the cryogenic fluid. A controller is coupled to the cascaded measurement sensors and configured to view the cascaded measurement sensors as a single sensor providing a single measurement. For example, the cascaded measurement sensors may be arranged in at least one of a series circuit, a parallel circuit, or a series-parallel circuit.

The cascaded measurement sensors are physically spaced within the container. Because the positions of the sensors in the container is known or predetermined, the position of the cryogenic fluid also may be determined relative to the sensors. In some embodiments, systems and methods may include a probe shell in which the cascaded measurement sensors are disposed at equal distances from adjacent sensors. Wiring of the cascaded measurement sensors emerges from cascaded measurement sensors and/or the probe shell as a single sensor measurement. In some embodiments, the single sensor measurement produced by the cascaded measurement sensors is in response to a temperature difference between the liquid phase and the vapor phase of the measured cryogenic fluid at each sensor of the cascaded measurement sensors.

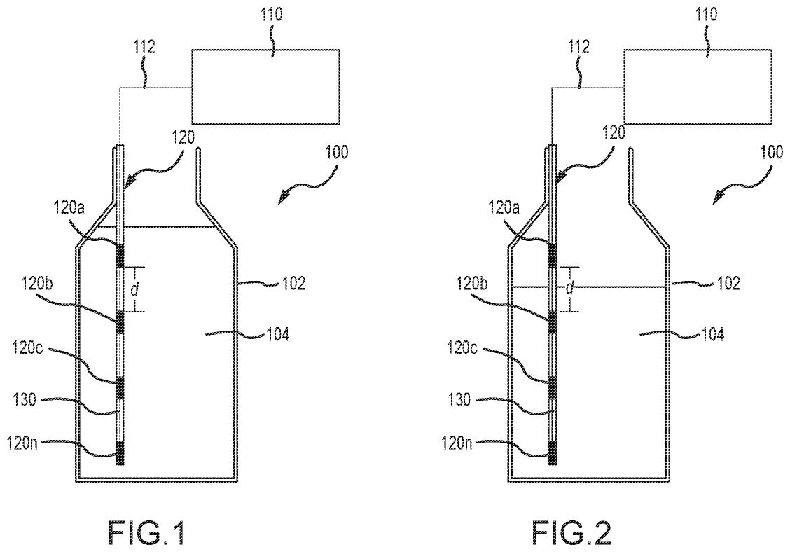

FIGS. 1 and 2 show diagrams of a system 100 for detecting a cryogenic fluid 104 level in a container 102, according to an embodiment. The system 100 may include a sensing device 120 and a controller 110 coupled to the sensing device. The container 102 may include any container for storing or holding cryogenic fluid and/or items to be stored in a cryogenic environment, such as a Dewar. The container 102 according to various embodiments may be sized and dimensioned to hold varying volumes of cryogenic fluid, such as about 10 L to about 600 L, about 10 L to about 50 L, about 50 L to about 100 L, about 100 L to about 150 L, about 150 L to about 200 L, about 200 L to about 250 L, about 250 L to about 300 L, about 300 L to about 350 L, about 350 to about 400 L, about 400 L to about 450 L, about 450 L to about 500 L, about 500 L to about 550 L, or about 550 L to about 600 L of cryogenic fluid. The cryogenic fluid 104 may include any cryogenic fluid, such as one or more of nitrogen, helium, argon, methane, or carbon monoxide.

The sensing device 120 includes a plurality of sensors, each sensor 120a, 120b, 120c, 120n of the plurality of sensors configured to provide a single measurement, according to an embodiment. The plurality of sensors may be coupled to one another via a wire 312 in a circuit to provide a single measurement to the controller 110. In the system 100 shown in FIGS. 1 and 2, the sensing device 120 includes four sensors. In some embodiments, the sensing device 120 of the system 100 includes at least two sensors (e.g., two, three, four, five, six, seven, eight, nine, ten, etc., sensors). Each sensor 120a, 120b, 120c, 120n of the plurality of sensors in the sensing device 120 is configured to detect a property relating to a phase of cryogenic fluid 104. For example, each sensor 120a, 120b, 120c, 120n of the plurality of sensors in the sensing device 120 may be configured to sense a property relating to the cryogenic fluid 104 that changes when the cryogenic fluid 104 transitions between a liquid phase and a vapor phase. The level of the cryogenic fluid 104 in the container may be detected by the plurality of sensors in the sensing device 120 detecting the transition of the cryogenic fluid 104 from the liquid phase to a vapor phase (e.g., each sensor 120a, 120b, 120c, 120n detecting or otherwise sensing a property relating to the cryogenic fluid 104 in the liquid phase or a property relating to the cryogenic fluid 104 in the vapor phase).

In many embodiments, each sensor 120a, 120b, 120c, 120n of the plurality of sensors in the sensing device 120 is spaced an equal distance d from an adjacent sensor of the plurality of sensors. The plurality of sensors in the sensing device 120 are coupled together and vertically spaced from one another when positioned in the container 102. By utilizing multiple sensors in the sensing device 120 spaced a fixed and/or equal distance apart, the level changes in the cryogenic fluid 104 can be determined and recorded. The transition of the cryogenic fluid 104 from the liquid phase to the vapor phase from one sensor to an adjacent sensor may be measured by, for example, the temperature recorded by each sensor 120a, 120b, 120c, 120n of the plurality of sensors in the sensing device 120. The plurality of sensors in the sensing device 120 are configured to produce a single measurement of the property detected by each sensor 120a, 120b, 120c, 120n of the plurality of sensors. As the positions of the sensors 120a, 120b, 120c, 120n in the container 102 is known or predetermined, the position of the cryogenic fluid 104 also can be determined relative to the sensors 120a, 120b, 120c, 120n as the cryogenic fluid transitions from a liquid phase to a vapor phase. In some embodiments, the plurality of sensors are disposed within a tube 130 at equal distances from one another.

Each sensor 120a, 120b, 120c, 120n may be spaced an equal and/or predetermined distance d from adjacent sensor(s) of the plurality of sensors. In some embodiments, each sensor 120a, 120b, 120c, 120n may be spaced from adjacent sensors about 0.5 inch to about 10 inches, about 0.5 to about 5 inches, about 5 inches to about 10 inches, about 0.5 inches to about 2.5 inches, about 2.5 inches to about 5 inches, about 5 inches about 7.5 inches, about 7.5 inches to about 10 inches, about 0.5 inch to about 1.5 inches, about 1.5 inches to about 2.5 inches, about 2.5 inches to about 3.5 inches, about 3.5 inches to about 4.5 inches, about 1 inch, about 2 inches, about 3 inches, about 4 inches, about 5 inches, about 6 inches, about 7 inches, about 8 inches, about 9 inches, 10 inches, less than about 10 inches, less than about 7.5 inches, less than about 5 inches, or less than about 2.5 inches.

In some embodiments, the plurality of sensors are disposed within a tube 130 or shell at equal distances from one another. The tube 130 may include stainless steel or other non-corrosive material. The tube 130 may be configured to allow or facilitate the desired spacing of the sensors 120a, 120b, 120c, 120d and/or to protect the sensors 120a, 120b, 120c, 120d from damage during handling.

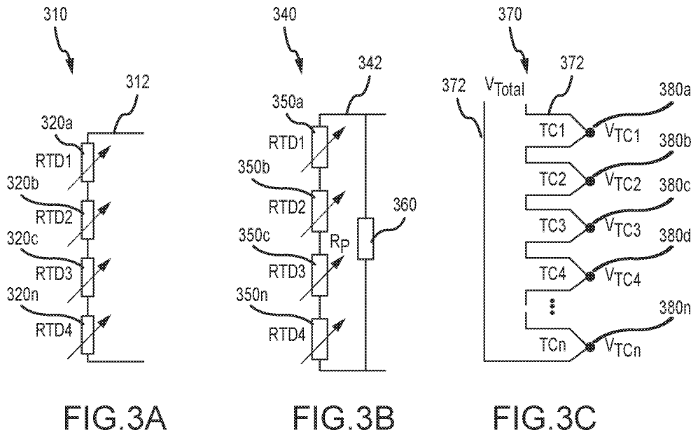

The plurality of sensors in the sensing device 120 are arranged or otherwise configured to produce a single measurement. For example, the plurality of sensors may be arranged in a series circuit, a parallel circuit, or combinations thereof (e.g., a series-parallel circuit). As provided above, each sensor 120a, 120b, 120c, 120n in the sensing device 120 may be configured to sense a property relating to the cryogenic fluid 104 that changes when the cryogenic fluid 104 transitions between a liquid phase and a vapor phase. Turning now to FIG. 3A, in some embodiments, the system 100 may include a sensing device 310 having a plurality of resistance temperature detectors (RTDs) 320a, 320b, 320c, 320n coupled via a wire 312 in a series circuit to provide a single measurement to the controller 110. In some embodiments, RTDs are used specifically with liquid oxygen and/or liquid nitrogen as the cryogenic fluid 104. Each RTD 320a, 320b, 320c, 320n in the sensing device 310 is configured to sense or detect a temperature of cryogenic fluid 104 in the liquid phase and the vapor phase.

The temperature of the cryogenic fluid is determined by the physical properties commonly used in cryogenic fluid. For example: liquid oxygen has a boiling point of −182.96° C. (−297.33° F.; 90.19 K) at 1 bar (15 psi), and a vapor temperature of −118.6° C. (−181.48° F.; 154.55 K). Liquid nitrogen has a boiling point of −195.8° C. (−320.4° F.; 77.4 K) at 1 bar (15 psi), and a vapor temperature −147.0° C. (−232.6° F.; 126.15 K). Each RTD 320a, 320b, 320c, 320n, then, may be configured to sense or detect a temperature associated with the cryogenic fluid 104 at the vapor phase and also at the liquid phase.

Each RTD 320a, 320b, 320c, 320n senses or detects distinct differences when immersed in the liquid phase versus the vapor phase of the cryogenic fluid 104. Accordingly, each RTD 320a, 320b, 320c, 320n is configured to sense or detect at least a first temperature relating to or associated with the liquid phase of the cryogenic fluid 104 and a second temperature different from the first temperature and relating to or associated with the vapor phase of the cryogenic fluid 104. Each RTD 320a, 320b, 320c, 320n includes a resistance that correlates to the temperature sensed or detected by the RTD 320a, 320b, 320c, 320n. Thus, resistance of each RTD 320a, 320b, 320c, 320n changes between a first resistance at the first temperature when the cryogenic fluid 104 is in a liquid phase and a second resistance at the second temperature when the cryogenic fluid 104 is in a vapor phase. The summation of the resistance of the plurality of sensors in the sensing device 310 delivers a proportional response to the level of the cryogenic fluid 104. The resultant resistance is then correlated to the temperature based on the appropriate RTD temperature versus resistance table. In some embodiments, the summation of the resistance of the plurality of sensors in the sensing device 310 may be determine using a formula:

Rₜₒₜₐₗ=Σᵢ₌₁ⁿ=R_{RTD}(n)

Turning now to FIG. 3B, in some embodiments, the system 100 may include a sensing device 340 having a plurality of resistance temperature detectors (RTDs) 350a, 350b, 350c, 350n coupled via a wire 342 in a parallel circuit to provide a single measurement to the controller 110. Each RTD 350a, 350b, 350c, 350n in the sensing device 340 is configured to sense or detect a temperature of cryogenic fluid 104 in the liquid phase and the vapor phase. Each RTD 350a, 350b, 350c, 350n senses or detects distinct differences when immersed in the liquid phase versus the vapor phase of the cryogenic fluid 104. Accordingly, each RTD 350a, 350b, 350c, 350n is configured to sense or detect at least a first temperature relating to or associated with the liquid phase of the cryogenic fluid 104 and a second temperature different from the first temperature and relating to or associated with the vapor phase of the cryogenic fluid 104. Each RTD 350a, 350b, 350c, 350n includes a resistance that correlates to the temperature sensed or detected by the RTD 350a, 350b, 350c, 350n. Thus, resistance of each RTD 350a, 350b, 350c, 350n changes between a first resistance at the first temperature when the cryogenic fluid 104 is in a liquid phase and a second resistance at the second temperature when the cryogenic fluid 104 is in a vapor phase. The summation of the resistance or temperature of the plurality of sensors in the sensing device 340 delivers a proportional response to the level of the cryogenic fluid 104. In an example, FIG. 3B demonstrates a system or method to scale the resistance of multiple RTDs 350a, 350b, 350c, 350n, thereby resulting in narrowing the resistance range of the sensing device 340. This scaling system and method in FIG. 3B may allow for a system or method that is capable of displaying a limited temperature range.

Turning now to FIG. 3C, in some embodiments, the system 100 may include a sensing device 370 having a plurality of thermocouples (TCs) 380a, 380b, 380c, 380d, 380n coupled via a wire 372 in a parallel circuit to provide a single measurement to the controller 110. Each thermocouple 380a, 380b, 380c, 380d, 380n in the sensing device 370 is configured to sense or detect a voltage (V) of cryogenic fluid 104 in the liquid phase and the vapor phase. In some embodiments, the thermocouples are used specifically with liquid helium as the cryogenic fluid 104. Each thermocouple 380a, 380b, 380c, 380d, 380n senses or detects distinct differences in voltage when immersed in the liquid phase versus the vapor phase of the cryogenic fluid 104. Accordingly, each thermocouple 380a, 380b, 380c, 380d, 380n is configured to sense or detect at least a first voltage relating to or associated with the liquid phase of the cryogenic fluid 104 and a second voltage different from the first voltage and relating to or associated with the vapor phase of the cryogenic fluid 104. Thus, voltage of each thermocouple 380a, 380b, 380c, 380d, 380n changes between a first voltage when the cryogenic fluid 104 is in a liquid phase and a second voltage when the cryogenic fluid 104 is in a vapor phase. The summation of the voltage of the plurality of sensors in the sensing device 370 delivers a proportional response to the level of the cryogenic fluid 104. In an example, the summation of the voltage of the plurality of sensors of the sensing device may be determined using a formula:

Vₜₒₜₐₗ=Σᵢ₌₁ⁿ=V_{TC}(n)

Returning to FIGS. 1 and 2, the controller 110 is coupled to the sensing device and configured to determine an approximate level of the cryogenic fluid 104 in the container 102 based on a single measurement derived from the sensing device 120 including the plurality of sensors. The single measurement from the plurality of sensors in the sensing device 120 is derived from (e.g., a summation of) the property detected by each sensor 120a, 120b, 120c, 120n of the plurality of sensors in the sensing device 120. For example, when the plurality of sensors in the sensing device 120 include a plurality of thermocouples, the controller 110 is configured to determine the approximate level of the cryogenic fluid 104 in the container 102 based on a single resistance measurement (e.g., a summation of resistance) derived from the plurality of thermocouples. When the plurality of sensors in the sensing device 120 include a plurality of thermocouples, the controller 110 is configured to determine the approximate cryogenic fluid 104 level in the container 102 based on a single voltage measurement (e.g., a summation of voltage) derived from the plurality of thermocouples.

The controller 110 is configured to determine approximately where the cryogenic fluid 104 level is relative to a position of one or more sensors 120a, 120b, 120c, 120n of the plurality of sensors in the sensing device 120. More specifically, the controller 110 is configured to determine approximately where the cryogenic fluid 104 level is relative to a position of two adjacent sensors of the plurality of sensors in the sensing device 120. For example, in FIG. 1, each sensor 120a, 120b, 120c, 120n is immersed in the liquid phase of the cryogenic fluid 104. Each sensor 120a, 120b, 120c, 120n, then, senses or detects a property (e.g., temperature/resistance or voltage) relating to the cryogenic fluid 104 in the liquid phase effective to result in a single measurement (e.g., resistance or voltage) for the plurality of sensors. The controller 110 is configured to use the single measurement (e.g., resistance or voltage) to determine the cryogenic fluid 104 level is above all of the sensors 120a, 120b, 120c, 120n.

Turning specifically to FIG. 2, the first sensor 102a is immersed in the vapor phase of the cryogenic fluid 104, while the sensors 120b, 120c, 120n are immersed in the liquid phase of the cryogenic fluid 104. The first sensor 120a, then, senses or detects a property (e.g., temperature/resistance or voltage) relating to the cryogenic fluid 104 in the vapor phase, and the sensors 120b, 120c, 120n sense or detect a property (e.g., temperature/resistance or voltage) relating to the cryogenic fluid 104 in the liquid phase that is different from the property in the vapor phase. In the example of FIG. 2, the plurality of sensors produce a single measurement (e.g., resistance or voltage) based on the first sensor 120a sensing or detecting the vapor phase and the sensors 120b, 120c, 120n detecting the liquid phase, the single measure for the example of FIG. 2 being different from the single measurement produced by the sensing device 120 when each sensor 120a, 120b, 120c, 120n was immersed in the liquid phase. The controller 110 is configured to use the single measurement (e.g., resistance or voltage) from the example shown in FIG. 2 to determine the cryogenic fluid 104 level is above the sensors 120b, 120c, 120n, but below the sensor 120a. Accordingly, the controller may use the single measurement from the example shown in FIG. 2 to determine the cryogenic fluid 104 level is between the first sensor 120a and the second sensor 120b. The response from each sensor 120a, 120b, 120c, 120n that results from the temperature/resistance or voltage change between the liquid phase and the vapor phase of the cryogenic fluid 104 is sufficiently large to result in a stair-step response when graphed. The temperature or voltage transition from one step to the next is of such magnitude that the need for highly accurate sensors is unnecessary. Further, as the positions of the sensors 120a, 120b, 120c, 120n in the container 102 is known or predetermined, the position of the cryogenic fluid 104 is also known relative to the sensors 120a, 120b, 120c, 120n.

In a specific example, four RTDs may be coupled together and spaced vertically from one another in liquid nitrogen held in the container 102. When all four RTDs are wholly immersed in liquid nitrogen, a single resistance measurement of 82.8 (corresponding to −55° C.) is derived from the four RTDs by the controller 110. When the level of the liquid nitrogen is between the top RTD and the second RTD from the top, a single resistance measurement of 93.4 (corresponding to −20° C.) is derived from the four RTDs by the controller 110. When the level of the liquid nitrogen is between the second RTD from the top and the second RTD from the bottom, a single resistance measurement of 104.1 (corresponding to 10° C.) is derived from the four RTDs by the controller 110. When the level of the liquid nitrogen is between the bottom RTD and the second RTD from the bottom, a single resistance measurement of 114.7 (corresponding to 40° C.) is derived from the four RTDs by the controller 110. The controller 110, then, may use the resistance/temperature measurements derived from the four RTDs to determine if the level the liquid nitrogen is above all four RTDs, between the top RTD and the second RTD from the top, between the second RTD from the top and the second RTD from the bottom, between the second RTD from the bottom and the bottom RTD, or below the bottom RTD.

In some embodiments, the controller 110 is configured to determine a rate of change of the cryogenic fluid from the liquid phase to the vapor phase using a rate of change between the detected properties of adjacent sensors. For example, the time between transition steps at each sensor 120a, 120b, 120c, 120n is a measure of the rate of depth change. When plotted, the resultant slope of the resistance/temperature or voltage may be used to compute the rate of change of the liquid loss in the cryogenic fluid 102. In some embodiments, the slope may be computed from each of the sensors 120a, 120b, 120c, 120n measuring the temperature or voltage. In some embodiments, the slope maybe reverse computed by converting the temperature from independent sensors to resistance, the resistance summed and converted to temperature. The temperatures or voltages may be plotted and the slope determined. In some embodiments, readings or measurements from the plurality of sensors in the sensing device 120 may be translated into independent analog to digital conversion devices for evaluation or use a single analog to digital conversion.

In some embodiments, the controller 110 is configured to coordinate an alert indicating that the cryogenic fluid 104 level is below a predetermined threshold. In some embodiments, the alert is coordinated and generated by the controller 110. In some embodiments, the controller 110 communicates with one or more electronic devices which generate an alert indicating that cryogenic fluid 104 level is below a predetermined threshold. For example, a predetermined threshold may include the cryogenic fluid 104 level being at or above the second sensor 120c from the bottom. When the controller 110 uses the single measurement from the sensing device 120 to determine the second sensor 120c from the bottom is immersed in the vapor phase rather than the liquid phase of the cryogenic fluid 104, the controller 110 may coordinate an alert.

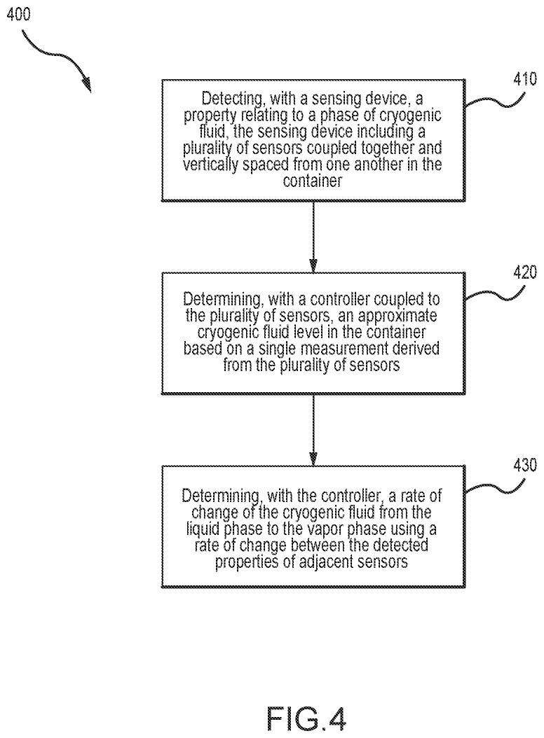

Turning now to FIG. 4, a method 400 for detecting a cryogenic fluid level in a container. The method 400 may include any aspect or acts of the system 100, the controller, and the sensing devices 120, 310, 340, 370 described above. In some embodiments, the method 400 includes an act 410 of detecting, with a sensing device, a property relating to a phase of cryogenic fluid, the sensing device including a plurality of sensors coupled together and vertically spaced from one another in the container. The method 400 also may include an act 420 of determining, with a controller coupled to the plurality of sensors, an approximate cryogenic fluid level in the container based on a single measurement derived from the plurality of sensors. The method 400 may optionally include an act 430 of determining, with the controller, a rate of change of the cryogenic fluid from the liquid phase to the vapor phase using a rate of change between the detected properties of adjacent sensors.

In some embodiments, the single measurement from the plurality of sensors is derived from the property detected by each sensor of the plurality of sensors. The act 420 may include determining approximately where the cryogenic fluid level is relative to a position of one or more sensors of the plurality of sensors. For example, the act 420 may include determining approximately where the cryogenic fluid level is relative to a position of two adjacent sensors of the plurality of sensors.

In some embodiments, the act 410 may include detecting with each sensor of the plurality of sensors, a property relating to the cryogenic fluid that changes when the cryogenic fluid transitions between a liquid phase and a vapor phase. More specifically, the act 410 may include detecting, with a plurality of RTDs, one of a first temperature relating to the liquid phase of the cryogenic fluid and a second temperature relating the vapor phase of the cryogenic fluid, wherein resistance of each RTD of the plurality of RTDs changes between a first resistance at the first temperature and a second resistance at the second temperature. In these and other embodiments, the act 420 may include determining, with the controller, the approximate cryogenic fluid level in the container based on a single resistance measurement derived from the plurality of RTDs.

In some embodiments, the act 410 may include detecting, with a plurality of thermocouples, one of a first voltage relating the liquid phase of the cryogenic fluid and a second voltage relating to the vapor phase of the cryogenic fluid. In these and other embodiments, the act 420 may include determining, with the controller, the approximate cryogenic fluid level in the container based on a single voltage measurement derived from the plurality of thermocouples.

In some embodiments of the method 400, the plurality of sensors are coupled together in one of a series circuit, a parallel circuit, or a series-parallel circuit. In some embodiments of the method 400, the plurality of sensors includes at least three sensors and each sensor of the plurality of sensors is spaced an equal distance from an adjacent sensor of the plurality of sensors.

Acts of the method 400 are for illustrative purposes. For example, the acts of the method 400 may be performed in different orders, split into multiple acts, modified, supplemented, or combined. Any of the acts of the method 400 may include using any of the systems, sensing devices, sensors, controllers, or containers disclosed herein.

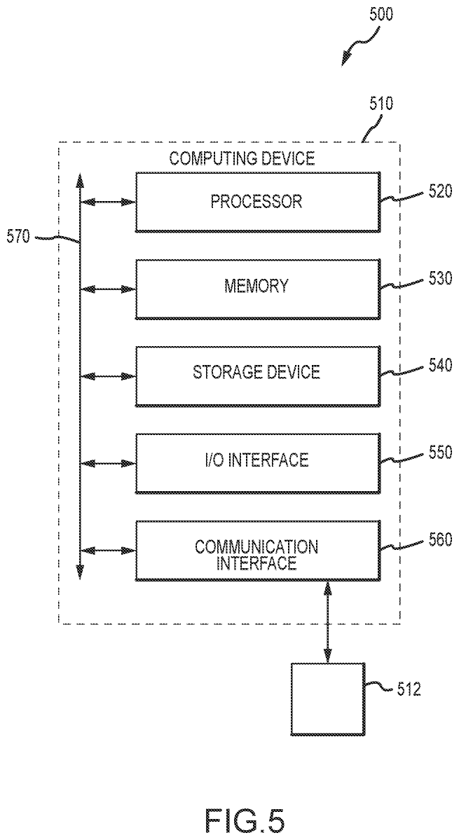

Any of the example systems disclosed herein may be used to carry out any of the example methods disclosed herein, such as using a controller. FIG. 5 is a schematic of a controller 500 for use in any of the system disclosed herein and/or executing any aspects of the example methods disclosed herein, according to an embodiment. Accordingly, the controller 110 may include any aspect of the controller 500. The controller 500 may be configured to implement any of the example methods disclosed herein, such as one more acts of the method 400 and/or one or more acts of the controller 110 in the system 100. The controller 500 includes at least one computing device 510. The at least one computing device 510 is an exemplary computing device that may be configured to perform one or more of the acts described above, such as one more acts of the method 400 and/or one or more acts of the controller 110 in the system 100. The at least one computing device 510 can include one or more servers, one or more computers (e.g., desk-top computer, lap-top computer), or one or more mobile computing devices (e.g., smartphone, tablet, etc.). The computing device 510 can comprise at least one processor 520, memory 530, a storage device 540, an input/output (“I/O”) device/interface 550, and a communication interface 560. While an example computing device 510 is shown in FIG. 5, the components illustrated in FIG. 5 are not intended to be limiting of the controller 500 or computing device 510. Additional or alternative components may be used in some examples. Further, in some examples, the controller 500 or the computing device 510 can include fewer components than those shown in FIG. 5. For example, the controller 500 may not include the one or more additional computing devices 512. In some examples, the at least one computing device 510 may include a plurality of computing devices, such as a server farm, computational network, or cluster of computing devices. Components of computing device 510 shown in FIG. 5 are described in additional detail below.

In some examples, the processor(s) 520 includes hardware for executing instructions (e.g., instructions for carrying out one or more portions of any of the methods disclosed herein), such as those making up a computer program. For example, to execute instructions, the processor(s) 520 may retrieve (or fetch) the instructions from an internal register, an internal cache, the memory 530, or a storage device 540 and decode and execute them. In particular examples, processor(s) 520 may include one or more internal caches for data such as look-up tables. As an example, the processor(s) 520 may include one or more instruction caches, one or more data caches, and one or more translation lookaside buffers (TLBs). Instructions in the instruction caches may be copies of instructions in memory 530 or storage device 540. In some examples, the processor 520 may be configured (e.g., include programming stored thereon or executed thereby) to carry out one or more portions of any of the example methods disclosed herein.

In some examples, the processor 520 is configured to perform any of the acts disclosed herein such as in the method 400 or associated with the controller 110, or cause one or more portions of the computing device 510 or controller 500 to perform at least one of the acts disclosed herein. Such configuration can include one or more operational programs (e.g., computer program products) that are executable by the at least one processor 520. For example, the processor 520 may be configured to automatically determine an approximate cryogenic fluid level in the container based on a single measurement derived from the plurality of sensors, determine a rate of change of the cryogenic fluid from the liquid phase to the vapor phase using a rate of change between the detected properties of adjacent sensors, and/or coordinate an alert when the cryogenic fluid drops below a predetermined level.

The at least one computing device 510 (e.g., a server) may include at least one memory storage medium (e.g., memory 530 and/or storage device 540). The computing device 510 may include memory 530, which is operably coupled to the processor(s) 520. The memory 530 may be used for storing data, metadata, and programs for execution by the processor(s) 520. The memory 530 may include one or more of volatile and non-volatile memories, such as Random Access Memory (RAM), Read Only Memory (ROM), a solid state disk (SSD), Flash, Phase Change Memory (PCM), or other types of data storage. The memory 530 may be internal or distributed memory.

The computing device 510 may include the storage device 540 having storage for storing data or instructions. The storage device 540 may be operably coupled to the at least one processor 520. In some examples, the storage device 540 can comprise a non-transitory memory storage medium, such as any of those described above. The storage device 540 (e.g., non-transitory storage medium) may include a hard disk drive (HDD), a floppy disk drive, flash memory, an optical disc, a magneto-optical disc, magnetic tape, or a Universal Serial Bus (USB) drive or a combination of two or more of these. Storage device 540 may include removable or non-removable (or fixed) media. Storage device 540 may be internal or external to the computing device 510. In some examples, storage device 540 may include non-volatile, solid-state memory. In some examples, storage device 540 may include read-only memory (ROM). Where appropriate, this ROM may be mask programmed ROM, programmable ROM (PROM), erasable PROM (EPROM), electrically erasable PROM (EEPROM), electrically alterable ROM (EAROM), or flash memory or a combination of two or more of these. In some examples, one or more portions of the memory 530 and/or storage device 540 (e.g., memory storage medium(s)) may store one or more databases thereon.

In some examples, data used in any of the systems and methods described herein may be stored in a memory storage medium such as one or more of the at least one processor 520 (e.g., internal cache of the processor), memory 530, or the storage device 540. In some examples, the at least one processor 520 may be configured to access (e.g., via bus 570) the memory storage medium(s) such as one or more of the memory 530 or the storage device 540. For example, the at least one processor 520 may receive and store the data (e.g., look-up tables) as a plurality of data points in the memory storage medium(s). The at least one processor 520 may execute programming stored therein adapted access the data in the memory storage medium(s) to automatically determine an approximate cryogenic fluid level in the container based on a single measurement derived from the plurality of sensors, determine a rate of change of the cryogenic fluid from the liquid phase to the vapor phase using a rate of change between the detected properties of adjacent sensors, and/or coordinate an alert when the cryogenic fluid drops below a predetermined level.

The computing device 510 also includes one or more I/O devices/interfaces 550, which are provided to allow a user to provide input to, receive output from, and otherwise transfer data to and from the computing device 510. These I/O devices/interfaces 550 may include a mouse, keypad or a keyboard, a touch screen, camera, optical scanner, network interface, web-based access, modem, a port, other known I/O devices or a combination of such I/O devices/interfaces 550. The touch screen may be activated with a stylus or a finger.

The I/O devices/interfaces 550 may include one or more devices for presenting output to a user, including, but not limited to, a graphics engine, a display (e.g., a display screen or monitor), one or more output drivers (e.g., display drivers), one or more audio speakers, and one or more audio drivers. In certain examples, I/O devices/interfaces 550 are configured to provide graphical data to a display for presentation to a user. The graphical data may be representative of one or more graphical user interfaces and/or any other graphical content as may serve a particular implementation.

The computing device 510 can further include a communication interface 560. The communication interface 560 can include hardware, software, or both. The communication interface 560 can provide one or more interfaces for communication (such as, for example, packet-based communication) between the computing device 510 and one or more additional computing devices 512 or one or more networks. For example, communication interface 560 may include a network interface controller (NIC) or network adapter for communicating with an Ethernet or other wire-based network or a wireless NIC (WNIC) or wireless adapter for communicating with a wireless network, such as a WI-FI.

Any suitable network and any suitable communication interface 560 may be used. For example, computing device 510 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, one or more portions of controller 500 or computing device 510 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination thereof. Computing device 510 may include any suitable communication interface 560 for any of these networks, where appropriate.

The computing device 510 may include a bus 570. The bus 570 can include hardware, software, or both that couples components of computing device 510 to each other. For example, bus 570 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination thereof.

It should be appreciated that any of the examples of acts of the controller 110 in the system 100 or the method 400 described herein may be performed by and/or at the computing device 510.

### Example 1

In an example, a sensing device including multiple RTD sensors (Pt100 RTD sensors) cascaded in series, as shown in FIG. 3A. The multiple RTD sensors were assembled into a single tube with the RTD sensors spaced equally from adjacent sensors. The basic functionality of an RTD is based on the principle that metal resistance will increase or decrease in relation to temperature. A temperature, then, was determined based on a specific resistance (and a specific resistance may be determined based on a specific temperature). Standards, such as IEC 60751, were used determine temperature/resistance profiles. These temperature/resistance profiles were then be used to determine a resistance value relevant to a particular temperature.

Liquid nitrogen measurements were accomplished in a lab setting (Boise, ID—altitude 2,700 feet). The liquid nitrogen fluid was allowed to evaporate naturally. The resistance calculations in Table 1 are based on IEC 60751 profiles and allow a resistance value to be calculated based on a temperature input.

TABLE 1
RTD Resistance In Liquid Nitrogen States

| State | Temp, ° C. | Resistance, Ω |
|---|---|---|
| Fluid | −197.5 | 19.6 |
| Vapor | −164.6 | 33.65 |

Table 2 is the cascaded RTD resistance versus the temperature of the four RTD sensors.

TABLE 2
Cascaded RTD Resistance vs. Temperature of Four Sensors

| | Resistance, Ω | | | | | Reported |
|---|---|---|---|---|---|---|
| | Probe | | | | Total | Temp, |
| State | RTD1 | RTD2 | RTD3 | RTD4 | Sum | ° C. |
| Fully Immersed | 19.6 | 19.6 | 19.6 | 19.6 | 78.4 | −57.9 |
| 75% Immersed | 33.65 | 19.6 | 19.6 | 19.6 | 92.5 | −20.1 |
| 50% Immersed | 33.65 | 33.65 | 19.6 | 19.6 | 106.5 | 17.4 |
| 25% Immersed | 33.65 | 33.65 | 33.65 | 19.6 | 120.6 | 55.2 |

The resistance of the cascaded sensor is represented by:

Rₜₒₜₐₗ=Σᵢ₌₁ⁿ=R_{RTD}(n)

That is, the summation of the resistance of each cascaded RTD sensor is realized as the total resistance, thus representing the temperature of the material being measured. Results of the implementation of the four element cascaded RTD sensors demonstrated a change in the single temperature measurement as the cryogenic fluid changed from a liquid phase to a vapor phase at each sensor of the multiple RTD sensors. It was further observed that computing the slope of the change in the single temperature measurement and noting the rate of change, the rate of loss of liquid nitrogen may be determined.

### Example 2

In an example, a prototype was assembled using two RTD sensors in a sensing device coupled to produce a single measurement. In the demonstrated response from the two RTD sensors, the level transition was visible for each of the three stages (e.g., both sensors immersed in the fluid phase of the liquid nitrogen; one sensor immersed in the fluid phase of the liquid nitrogen and one sensor in the vapor phase of the liquid nitrogen; and both sensors in the vapor phase of the liquid nitrogen, shown in Table 3). It was observed that the slope of the temperature profile became much more pronounced. The temperature transition and slope data became a source of information to compute the use over time of the nitrogen levels.

TABLE 3
Cascaded RTD Resistance vs.
Temperature, Two RTD Sensors

| State | RTD1 | RTD2 | Temp | Actual |
|---|---|---|---|---|
| Fully Immersed | 19.6 | 19.6 | −150 | −148.7 |
| 50% Immersed | 33.65 | 19.6 | −117 | −123.6 |
| 0% Immersed | 33.65 | 33.65 | −81 | −71.5 |

The graphed temperature of the single temperature measurement from the two RTD sensors resulted in a pronounced slope. This slope determination was be accomplished via physical measurements or reverse computation. The slope that results from the temperature measurement is the desired outcome from this system. The novelty of a single sensing probe comprised of n sensing elements provides the end result. Given the desired outcome is the slope of the temperature, the same outcome can be accomplished using two independent sensors measuring the temperature. By recording the temperatures of the two independent sensors, the temperature value was converted to the resistance of the RTD sensor. The resistance of each independent RTD sensor was summed and that value was converted to temperature, as shown in Table 4.

TABLE 5
Reverse Computation

| State | T_{RTD1} | T_{RTD2} | R_{RTD1} | R_{RTD2} | R_{Total} | Temp |
|---|---|---|---|---|---|---|
| Fully Immersed | −197 | −197 | 21.5 | 21.5 | 43.0 | −148.7 |
| 50% Immersed | −160 | −197 | 35.5 | 21.5 | 57.0 | −109 |
| 0% Immersed | −160 | −160 | 35.5 | 35.5 | 71.0 | −78 |

As used herein, the term “about” or “substantially” refers to an allowable variance of the term modified by “about” by ±10% or ±5%. Further, the terms “less than,” “or less,” “greater than”, “more than,” or “or more” include as an endpoint, the value that is modified by the terms “less than,” “or less,” “greater than,” “more than,” or “or more.”

While various aspects and embodiments have been disclosed herein, other aspects and embodiments are contemplated. The various aspects and embodiment disclosed herein are for purposes of illustration and are not intended to be limiting.

1. A system for detecting a cryogenic fluid level in a container, the system comprising:
a sensing device including a plurality of sensors, each sensor of the plurality of sensors being configured to detect a property relating to a phase of cryogenic fluid, the plurality of sensors being coupled together and vertically spaced from one another when positioned in the container; and
a controller coupled to the sensing device and configured to determine an approximate cryogenic fluid level in the container based on a single measurement derived from the plurality of sensors.

2. The system of claim 1, wherein the single measurement from the plurality of sensors is derived from the property detected by each sensor of the plurality of sensors.

3. The system of claim 1, wherein the controller is configured to determine approximately where the cryogenic fluid level is relative to a position of one or more sensors of the plurality of sensors.

4. The system of claim 3, wherein the controller is configured to determine approximately where the cryogenic fluid level is relative to a position of two adjacent sensors of the plurality of sensors.

5. The system of claim 1, wherein each sensor of the plurality of sensors is configured to sense a property relating to the cryogenic fluid that changes when the cryogenic fluid transitions between a liquid phase and a vapor phase.

6. The system of claim 5, wherein:
the plurality of sensors includes a plurality of resistance temperature detectors (RTDs) configured to sense a first temperature relating to the liquid phase of the cryogenic fluid and a second temperature relating the vapor phase of the cryogenic fluid;
resistance of each RTD of the plurality of RTDs changes between a first resistance at the first temperature and a second resistance at the second temperature;
the controller is configured to determine the approximate cryogenic fluid level in the container based on a single resistance measurement derived from the plurality of RTDs.

7. The system of claim 5, wherein:
the plurality of sensors includes a plurality of thermocouples configured to sense a first voltage relating the liquid phase of the cryogenic fluid and a second voltage relating to the vapor phase of the cryogenic fluid; and
the controller is configured to determine the approximate cryogenic fluid level in the container based on a single voltage measurement derived from the plurality of thermocouples.

8. The system of claim 5, wherein the controller is configured to determine a rate of change of the cryogenic fluid from the liquid phase to the vapor phase using a rate of change between the detected properties of adjacent sensors.

9. The system of claim 1, wherein the plurality of sensors are coupled together in one of a series circuit, a parallel circuit, or a series-parallel circuit.

10. The system of claim 1, wherein the plurality of sensors includes at least three sensors and each sensor of the plurality of sensors is spaced an equal distance from an adjacent sensor of the plurality of sensors.

11. A method for detecting a cryogenic fluid level in a container, the method comprising:
detecting, with a sensing device, a property relating to a phase of cryogenic fluid, the sensing device including a plurality of sensors coupled together and vertically spaced from one another in the container; and
determining, with a controller coupled to the plurality of sensors, an approximate cryogenic fluid level in the container based on a single measurement derived from the plurality of sensors.

12. The method of claim 11, wherein the single measurement from the plurality of sensors is derived from the property detected by each sensor of the plurality of sensors.

13. The method of claim 11, wherein determining an approximate cryogenic fluid level in the container includes determining approximately where the cryogenic fluid level is relative to a position of one or more sensors of the plurality of sensors.

14. The method of claim 13, wherein determining approximately where the cryogenic fluid level is relative to a position of one or more sensors of the plurality of sensors includes determining approximately where the cryogenic fluid level is relative to a position of two adjacent sensors of the plurality of sensors.

15. The method of claim 11, wherein detecting, with a plurality of sensors, a property relating to a phase of cryogenic fluid includes detecting with each sensor of the plurality of sensors, a property relating to the cryogenic fluid that changes when the cryogenic fluid transitions between a liquid phase and a vapor phase.

16. The method of claim 15, wherein:
detecting with each sensors of the plurality of sensors, a property relating to the cryogenic fluid that changes when the cryogenic fluid transitions between a liquid phase and a vapor phase includes:
detecting, with a plurality of resistance temperature detectors (RTDs), one of a first temperature relating to the liquid phase of the cryogenic fluid and a second temperature relating the vapor phase of the cryogenic fluid, wherein resistance of each RTD of the plurality of RTDs changes between a first resistance at the first temperature and a second resistance at the second temperature;
determining, with a controller coupled to the plurality of sensors, an approximate cryogenic fluid level in the container based on a single measurement derived from the plurality of sensors includes:
determining, with the controller, the approximate cryogenic fluid level in the container based on a single resistance measurement derived from the plurality of RTDs.

17. The method of claim 15, wherein:
detecting with each sensors of the plurality of sensors, a property relating to the cryogenic fluid that changes when the cryogenic fluid transitions between a liquid phase and a vapor phase includes:
detecting, with a plurality of thermocouples, one of a first voltage relating the liquid phase of the cryogenic fluid and a second voltage relating to the vapor phase of the cryogenic fluid; and
determining, with a controller coupled to the plurality of sensors, an approximate cryogenic fluid level in the container based on a single measurement derived from the plurality of sensors includes:
determining, with the controller, the approximate cryogenic fluid level in the container based on a single voltage measurement derived from the plurality of thermocouples.

18. The method of claim 15, further comprising determining, with the controller, a rate of change of the cryogenic fluid from the liquid phase to the vapor phase using a rate of change between the detected properties of adjacent sensors.

19. The method of claim 11, wherein the plurality of sensors are coupled together in one of a series circuit, a parallel circuit, or a series-parallel circuit.

20. The method of claim 11, wherein the plurality of sensors includes at least three sensors and each sensor of the plurality of sensors is spaced an equal distance from an adjacent sensor of the plurality of sensors.
